(19) United States
(12) Patent Application Publication
(10) Pub. No.: US 2025/0199883 A1
(43) Pub. Date: Jun. 19, 2025

(54) SYSTEM AND METHOD FOR INITIATING AN EXISTING WORKFLOW BASED ON AN ARTIFICIAL EVENT

(71) Applicant: MOTOROLA SOLUTIONS, INC., CHICAGO, IL (US)

(72) Inventor: FILIP NORYS, CHRZANOW (PL)

(21) Appl. No.: 18/537,923

(22) Filed: Dec. 13, 2023

(51) Int. Cl. G06F 9/54; G06F 11/34; G06F 16/2457; G06F 21/62

(52) U.S. Cl. CPC G06F 9/542; G06F 11/3476; G06F 16/24578; G06F 21/6218

(57) ABSTRACT

Techniques for initiating an existing workflow at a workflow server based on an artificial event notification are provided. An artificial event notification is received from a source external to a security ecosystem. The artificial event notification is related to an incident. The artificial event notification is mapped to a currently existing workflow within the workflow server. The currently existing workflow is associated with an internal trigger. The currently existing workflow is initiated based on the artificial event notification without receiving the internal trigger.

### BACKGROUND OF THE INVENTION

Managing multiple devices within a security ecosystem can be a time-consuming and challenging task. This task typically requires an in-depth knowledge of each type of device within the security ecosystem in order to produce a desired workflow when a security event is detected. For example, consider a school system that employs a security ecosystem comprising a radio communication system, a video security system, and a door access control system. Assume that an administrator wishes to implement a first workflow that notifies particular radios if a door breach is detected. Assume that the administrator also wishes to implement a second workflow that also notifies the particular radios when a security camera detects loitering. In order to implement these two workflows, the access control system may have to be configured to provide the notifications to the radios and the video security system may have to be configured to provide the notifications to the radios. Thus, both the access control system and the video security system may need to be configured separately in order to implement the two workflows. As is evident, this requires the administrator to have an in-depth knowledge of both the video security system and the access control system. Thus, the lack of continuity across systems is a burden to administrators since an in-depth knowledge of all systems within the ecosystem may be needed in order to properly configure workflows within the ecosystem.

In order to reduce the burden on administrators and enhance their efficiency, a need exists for a user-friendly interface tool that gives administrators the ability to configure and automate workflows that control their integrated security ecosystem. It would also be beneficial if such a tool equips administrators with the capabilities they need to detect triggers across a number of installed devices/systems and quickly take actions (execute workflows) to reduce the risk of breaches and downtime by automatically alerting the appropriate teams and executing the proper procedures.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a security ecosystem capable of configuring and automating workflows.

FIG. 2 illustrates a security ecosystem capable of configuring and automating workflows.

FIG. 3 illustrates a security ecosystem capable of configuring and automating workflows.

FIG. 5 illustrates a security ecosystem capable of configuring and automating workflows.

FIG. 4 illustrates a security ecosystem capable of configuring and automating workflows.

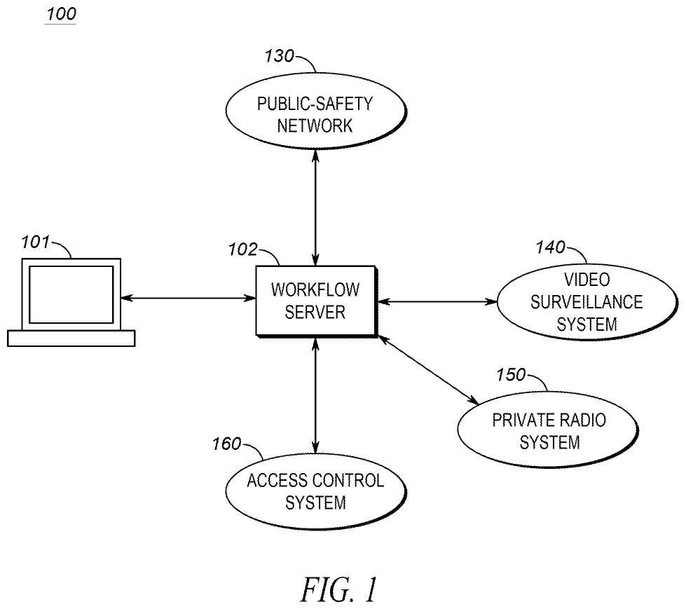

FIG. 6 is a block diagram of a workflow server of FIG. 1.

FIG. 7 is a block diagram of a workstation of FIG. 1 utilized to create a workflow.

FIG. 8 illustrates the creation of a workflow.

FIG. 9 illustrates the creation of a workflow.

FIG. 10 illustrates the creation of a workflow.

FIG. 11 is an example of a communications system that may implement the aggregator service to initiate a workflow based on an artificial event.

FIG. 12 illustrates an example environment in which reception of an artificial event, selecting a currently existing workflow based on the artificial event, and initiating the workflow is depicted.

FIG. 13 is an example flow chart describing receiving an artificial event and initiating a workflow according to techniques described herein.

FIG. 14 is an example flow chart for the aggregator service querying the workflow server to determine when to send an artificial event.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In order to address the above-mentioned need, a system, method, and apparatus for implementing workflows across multiple differing systems and devices is provided herein. A workflow server may be used to allow a user to create workflows from multiple disparate systems. For example, an enterprise may have video surveillance systems, private radio systems, and access control systems. Workflows may be generated such that when an event (e.g. a trigger) in one of those systems is detected, an action may be taken by another system. For example, if the video surveillance system detects that a person is loitering by a door, the action performed may be to dispatch a security guard to the loitering location.

It should be noted that the previously described systems are generally all under the control of the enterprise. As such, sharing of information between the various systems and the workflow server is not an issue, as all of those systems are under common control/ownership and form a security ecosystem.

The workflow server may also be connected to other systems that are not under the control of the enterprise. For example, the workflow server may be connected to a public safety network (e.g. police, fire, emergency medical services, etc.). A trigger event, such as loitering may occur. The action performed may be to cause a police officer to be dispatched to the scene of loitering, just as was described above with respect to a security guard being dispatched. It should be noted that communication with the public safety system is generally from the workflow server to the public safety system to cause the public safety system to take some action. The public safety system generally does not send triggers to the workflow server to cause the workflow server to initiate a workflow. Although the public safety system is not under the control of the workflow server, it can also be considered part of the security ecosystem.

A problem arises in that there are many other sources of potential triggers that are not under the control of the workflow server and are, as such, external to the security ecosystem. For example, there exists a variety of applications that may allow people to report crimes or suspicious activity (e.g. TipSubmit, Crime Stoppers, etc.). These reports may be of interest to the workflow server because the reports may be related to the security eco system.

Yet another example of a source of potential triggers are social media monitoring systems. For example, it is known that social media has been used in the past to organize criminal activity (e.g. flash mob shoplifting, etc.). Similarly, conventional media may also be a source of potential triggers. Often times the ordinary media may report on issues (e.g. potential rioting, crowd gathering, etc.).

The techniques described herein provide an aggregator service that may monitor potential sources of triggers for the workflow server from sources external to the security eco system. When such a trigger is detected, the aggregator service may send an artificial event to the workflow server related to whatever incident the aggregator service is aware of. It is referred to as an artificial event because the aggregator service is not under the control of the workflow server and as such, does not know what triggers actually are available within the workflow server. The artificial event may eventually cause a workflow to be initiated, but it would not be initiated based on a real trigger received from within the security ecosystem.

The workflow server within the security ecosystem may then attempt to map the artificial event to a currently existing workflow. Because the artificial event is not an actual trigger, there may be multiple possible workflows that could be associated with the artificial event. The workflow server uses information included in the artificial event to determine which, if any, workflows should be initiated.

The workflow server may cause the determined workflow to be initiated. In some implementations, the artificial event may be converted into a trigger associated with the workflow, and the trigger is processed as if it were generated from within the security ecosystem. In other implementations, the workflow server may simply cause the workflow to be initiated. What should be understood is the determined workflow is initiated without a trigger that was generated from inside the security ecosystem.

A method of initiating an existing workflow at a workflow server based on an artificial event notification is provided. The method comprises receiving, from a source external to a security ecosystem, an artificial event notification, the artificial event notification related to an incident. The method also comprises mapping the artificial event notification to a currently existing workflow within the workflow server, the currently existing workflow associated with an internal trigger. The method also comprises initiating the currently existing workflow based on the artificial event notification without receiving the internal trigger.

In one aspect, the method comprises determining if the artificial event notification is actionable prior to initiating the currently existing workflow and logging the artificial event notification as non-actionable based on the determination. In one aspect, the method comprises registering the workflow server with the source external to the security ecosystem, the registration including types and parameters of incidents for which the workflow server is interested in receiving artificial event notifications. In one aspect of the method, the parameters include at least one of a location of the incident, a time of incident occurrence, and an incident type.

In one aspect, the method comprises receiving, from the source external to the security ecosystem, a query including an event type, determining an event type relevance of the event type, and responding to the query with the event type relevance, wherein the source external to the security ecosystem uses the event type relevance to determine if the artificial event notification is sent to the workflow server. In one aspect, the method comprises determining workflows in the workflow server that are compatible with the event type, ranking the determined workflows, and analyzing the determined workflows based on acceptable time delay and location of the event type. In one aspect of the method the workflow server receives the artificial event notification based on a physical proximity of the workflow server to the source external to the security ecosystem.

A system for initiating an existing workflow at a workflow server based on an artificial event notification is provided. The system comprises a processor and a memory coupled to the processor, the memory containing a set of instructions thereon that when executed by the processor cause the processor to receive, from a source external to a security ecosystem, an artificial event notification, the artificial event notification related to an incident. The instructions on the memory further comprise instructions that cause the processor to map the artificial event notification to a currently existing workflow within the workflow server, the currently existing workflow associated with an internal trigger. The instructions on the memory further comprise instructions that cause the processor to initiate the currently existing workflow based on the artificial event notification without receiving the internal trigger.

In one aspect, the instructions on the memory further comprise instructions that cause the processor to determine if the artificial event notification is actionable prior to initiating the currently existing workflow and log the artificial event notification as non-actionable based on the determination. In one aspect, the instructions on the memory further comprise instructions that cause the processor to register the workflow server with the source external to the security ecosystem, the registration including types and parameters of incidents for which the workflow server is interested in receiving artificial event notifications. In one aspect, the parameters include at least one of a location of the incident, a time of incident occurrence, and an incident type.

In one aspect, the instructions on the memory further comprise instructions that cause the processor to receive, from the source external to the security ecosystem, a query including an event type, determine an event type relevance of the event type, and respond to the query with the event type relevance, wherein the source external to the security ecosystem uses the event type relevance to determine if the artificial event notification is sent to the workflow server. In one aspect, the instructions on the memory further comprise instructions that cause the processor to determine workflows in the workflow server that are compatible with the event type, rank the determined workflows, and analyze the determined workflows based on acceptable time delay and location of the event type. In one aspect, the workflow server receives the artificial event notification based on a physical proximity of the workflow server to the source external to the security ecosystem.

A non-transitory processor readable medium containing a set of instructions thereon is provided. The instructions on the medium, that when executed by a processor, cause the processor to receive, from a source external to a security ecosystem, an artificial event notification, the artificial event notification related to an incident. The instructions on the medium cause the processor to map the artificial event notification to a currently existing workflow within the workflow server, the currently existing workflow associated with an internal trigger. The instructions on the medium cause the processor to initiate the currently existing workflow based on the artificial event notification without receiving the internal trigger.

In one aspect, the instructions on the medium cause the processor to determine if the artificial event notification is actionable prior to initiating the currently existing workflow and log the artificial event notification as non-actionable based on the determination. In one aspect, the instructions on the medium cause the processor to register the workflow server with the source external to the security ecosystem, the registration including types and parameters of incidents for which the workflow server is interested in receiving artificial event notifications. In one aspect, the parameters include at least one of a location of the incident, a time of incident occurrence, and an incident type.

In one aspect, the instructions on the medium cause the processor to receive, from the source external to the security ecosystem, a query including an event type, determine an event type relevance of the event type, and respond to the query with the event type relevance, wherein the source external to the security ecosystem uses the event type relevance to determine if the artificial event notification is sent to the workflow server. In one aspect, the instructions on the medium cause the processor to determine workflows in the workflow server that are compatible with the event type, rank the determined workflows, and analyze the determined workflows based on acceptable time delay and location of the event type.

Each of the above-mentioned aspects will be discussed in more detail below, starting with example system and device architectures of the system in which the embodiments may be practiced, followed by an illustration of processing blocks for achieving a system and method for a connector application to cause an action to be executed by a public safety device.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

Turning now to the drawings, wherein like numerals designate like components, FIG. 1 illustrates a security ecosystem 100 capable of configuring and automating workflows across multiple systems. The security ecosystem 100 is interchangeably referred to hereafter as the system 100.

The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

As shown, the security ecosystem 100 comprises a public-safety network 130, a video surveillance system 140, a private the private radio system 150, and an access control system 160. The workflow server 102 is coupled to each system 130, 140, 150, and 160. The workstation 101 is shown coupled to the workflow server 102, and is utilized to configure the workflow server 102 with workflows, for example as created by a user. It should be noted that although the components in FIG. 1 are shown geographically separated, these components can exist within a same geographic area, such as, but not limited to a school, a hospital, an airport, a sporting event, a stadium, a factory, a warehouse and/or any other suitable location and/or building and the like. It should also be noted that although only networks and systems 130, 140, 150, 160 are shown in FIG. 1, many more networks and/or systems may be included in the security ecosystem 100 and/or any suitable number of networks and/or systems may be included in the security ecosystem 100.

The workstation 101 may comprise a computer configured to execute Motorola Solution's Orchestrate™ and Ally™ dispatch and incident management software. As will be discussed in more detail below, the workstation 101 is configured to present a user with a plurality of triggers capable of being detected by the network and systems 130, 140, 150, 160 as well as present the user with a plurality of actions capable of being executed by the network and systems 130, 140, 150, 160. The user will be able to create workflows and upload these workflows to the workflow server 102 based on the presented triggers and actions.

The workflow server 102 may comprise a server running Motorola Solution's Command Central™ software suite comprising the Orchestrate™ platform. The workflow server 102 is configured to receive workflows created by the workstation 101 and implement the workflows. Particularly, the workflows are implemented by analyzing events detected by the network and systems 130, 140, 150, 160 and executing appropriate triggers. In a particular example, a user may create a workflow on the workstation 101 that has a trigger comprising the video surveillance system 140 detecting a loitering event, and has an action comprising notifying radios within the public-safety network 130. When this workflow is uploaded to the workflow server 102, the workflow server 102 will notify the radios of any loitering event detected by the video surveillance system 140.

The public-safety network 130 is configured to detect various triggers and report the detected triggers to the workflow server 102. The public-safety network 130 is also configured to receive action commands from the workflow server 102 and execute the actions. In some examples, the public-safety network 130 comprises includes typical radio-access network (RAN) elements such as base stations, base station controllers (BSCs), routers, switches, and the like, arranged, connected, and programmed to provide wireless service to user equipment, report detected events, and execute actions received from the workflow server 102.

The video surveillance system 140 is configured to detect various triggers and report the detected triggers to the workflow server 102. The video surveillance system 140 is also configured to receive action commands from the workflow server 102 and execute the actions. In one example, the video surveillance system 140 comprises a plurality of video cameras that may be configured to automatically change their field of views over time. The video surveillance system 140 is configured with a recognition engine/video analysis engine (VAE) that comprises a software engine that analyzes any video captured by the cameras. Using the VAE, the video surveillance system 140 is capable of “watching” video to detect any triggers and report the detected triggers to the workflow server 102. These triggers may include, but are not limited to, appearance searches and unusual Activity Detection (e.g., loitering). In a similar manner, the video surveillance system 140 is configured to execute action commands received from the workflow server 102. In some examples, the video surveillance system 140 comprises an Avigilon™ Control Center (ACC) server having Motorola Solution's Access Control Management (ACM)™ software suite.

The private radio system 150 may comprise a private enterprise radio system that is configured to detect various triggers and report the detected triggers to the workflow server 102. The private radio system 150 is also configured to receive action commands from the workflow server 102 and execute the actions. In some examples, the private radio system 150 comprises a MOTOTRBO™ communication system having radio devices that operate in the Citizens Broadband Radio Service (CBRS) spectrum and combines broadband data with voice communications.

The access control system 160 comprises an Internet-of-Things (IoT) network which may serve to connect every-day devices to the Internet. Devices such as cars, kitchen appliances, medical devices, sensors, doors, windows, HVAC (heating, ventilation, and air conditioning) systems, drones, . . . , etc. can all be connected through the IoT network of the access control system 160. Indeed, any suitable device that can be powered may be connected to the internet to control its functionality. The access control system 160 generally allows objects to be sensed or controlled remotely across existing network infrastructure. For example, the access control system 160 may be configured to provide access control to various doors and windows. In particular, the access control system 160 is configured to detect various triggers (e.g., door opened/closed) and report the detected triggers to the workflow server 102. The access control system 160 is also configured to receive action commands from the workflow server 102 and execute the action received from the workflow server 102. The action commands may take the form of instructions to lock, open, and/or close a door or window.

As is evident, the security ecosystem 100 allows an administrator using the workstation 101 to create rule-based, automated workflows between technologies to enhance efficiency, and improve response times, effectiveness, and overall safety. The above the security ecosystem 100 has the capability to detect triggers across a number of devices within network and systems 130, 140, 150, 160 quickly take actions by automatically executing the proper procedure (i.e., executing the appropriate action once a trigger is detected).

The network and systems 130, 140, 150, 160 are next described in further detail.

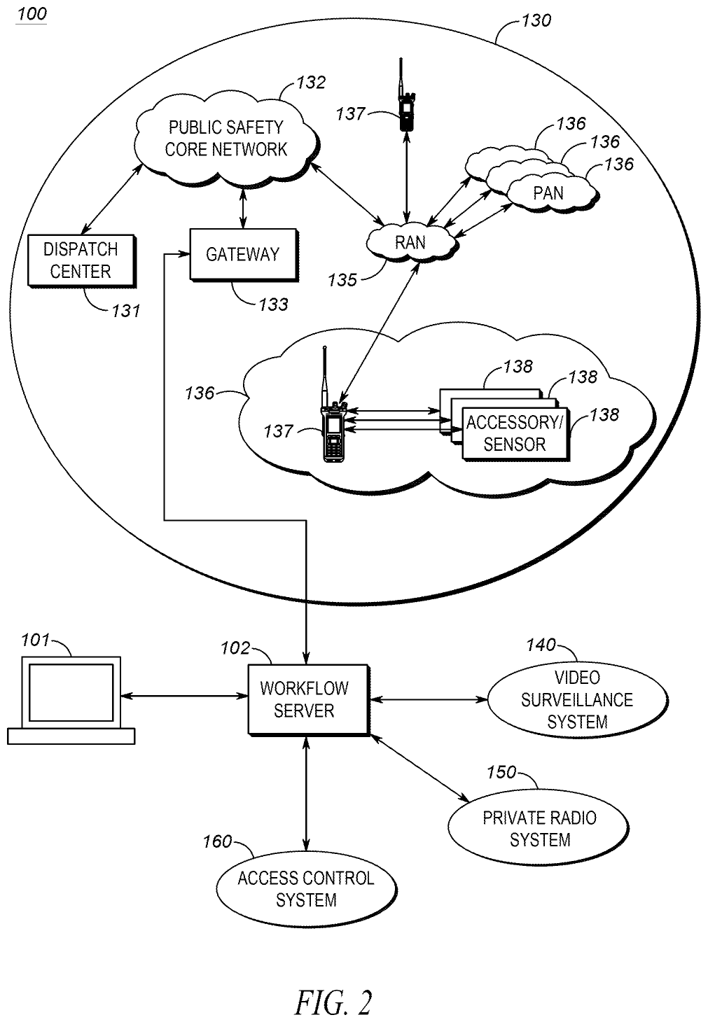

FIG. 2 illustrates a security ecosystem capable of configuring and automating workflows. In particular, FIG. 2 shows the security ecosystem 100 with an expanded view of the public-safety network 130. As shown, the public-safety network 130 comprises a dispatch center 131, a public-safety core network 132, a gateway 133, a radio access network (RAN) 135, a plurality of personal-area networks (PANs) 136, and at least radio 137, such as a public-safety radio and the like. As shown, each PAN 136 comprises a radio 137 acting as a hub to smart devices/accessories/sensor 138 (interchangeably referred to hereafter as the sensors and/or a sensor 138).

The gateway 133 may comprise an Avigilon™ Control Center running Avigilon's Access Control Management software. The gateway 133 is configured to run any suitable Application Program Interface (API) to provide communications between the public-safety core network 132 and the workflow server 102.

A public safety officer (not shown in FIG. 2) may be equipped with sensors 138 that determine various physical and environmental conditions surrounding the public-safety officer. These conditions may be reported back to, for example, the dispatch center 131 or the workflow server 102 so an appropriate action may be taken. For example, police officers may have a sensor 138 (e.g. in the form of a gun-draw sensor) that determines when a gun is drawn. Upon detecting that an officer has drawn their gun, a notification may be sent back to the dispatch operator and/or the workflow server 102 so that, for example, other officers in the area may be notified of the situation.

It is envisioned that the public-safety officer may have an array of these sensors 138 available to the officer at the beginning of a shift. The officer may select and pull sensors 138 off a shelf, and form a personal-area network (PAN) 136 with the devices that may accompany the officer on their shift. For example, the officer may pull a gun-draw sensor, a body-worn camera, a wireless microphone, a smart watch, a police radio, smart handcuffs, a man-down sensor, a bio-sensor, and the like. All sensors 138 pulled by the officer may be configured to form a PAN 136 by associating (pairing) with each other and communicating wirelessly among the devices. At least one device may be configured with a digital assistant. In some examples, a PAN 136 comprises more than two sensors 138, so that many sensors 138 may be connected via a PAN 136 simultaneously.

A method called bonding may be used for recognizing specific sensors 138 and thus enabling control over which accessories are allowed to connect to each other when forming a PAN 136. Once bonded, accessories then can establish a connection without user intervention. A bond may be created through a process called “pairing”. The pairing process may be triggered by a specific request by the user to create a bond from a user via a user interface on the accessories. Thus, as shown, public-safety network 130 incorporates PANs 136 created as described above. In some examples, radios 137 and sensors 138 form a PAN 136, with communication links between sensors 138 and radios 137 taking place utilizing a short-range communication system protocol such as a Bluetooth communication system protocol. In this particular example, a PAN 136 may be associated with a single officer. Thus, FIG. 2 illustrates multiple PANs 136 associated with multiple officers (not shown).

The RAN 135 may include various RAN elements such as base stations, base station controllers (BSCs), routers, switches, and the like, arranged, connected, and programmed to provide wireless service to user equipment (e.g., the radios 137, and the like) in a manner known to those of skill in the relevant art. The RAN 135 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other examples, the RAN 135 may implement a Long Term Evolution (LTE), LTE-Advance, or 5G protocol including multimedia broadcast multicast services (MBMS) or single site point-to-multipoint (SC-PTM) (including, but not limited to open mobile alliance (OMA) push to talk (PTT) over cellular (OMA-PoC)), a voice over IP (VOIP), an LTE Direct or LTE Device to Device, or a PTT over IP (PoIP) application may be implemented. In still further examples, the RAN 135 may implement a Wi-Fi protocol for example operating in accordance with an IEEE 802.11 standard (e.g., 802.11a, 802.11b, 802.11g) or a WiMAX protocol for example operating in accordance with an IEEE 802.16 standard.

The public-safety core network 132 may include one or more packet-switched networks and/or one or more circuit-switched networks, and in general provides one or more public-safety agencies with any suitable computing and communication needs, transmitting any suitable public-safety-related data and communications.

For narrowband LMR wireless systems, the public-safety core network 132 may operate in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some examples, group IDs (identifiers) may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Group calls may be made between radios 137 and other devices via wireless transmissions in accordance with either a narrowband or a broadband protocol or standard. Group members for group calls may be statically or dynamically defined. That is, in a first example, a user or administrator may indicate to the switching and/or radio network (such as at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) c based on user input, and the switching and/or radio network may track group membership and route new group calls according to the current group membership.

The radios 137 generally serve as PAN main devices, and may be any suitable computing and communication device configured to engage in wireless communication with the RAN 135 over the air interface as is known to those in the relevant art. Moreover, one or more radios 137 are further configured to engage in wired and/or wireless communication with one or more local sensor 138 via a local communication link. The radios 137 may be configured to determine when to forward information received from PA sensors 138 to, for example, a dispatch center or the workflow server 102.

Some examples of sensors 138 follow:

In some examples, a sensor 138 may comprise a sensor-enabled holster that maintains and/or provides state information regarding a weapon or other item normally disposed within the user's sensor-enabled holster. The sensor-enabled holster may detect a change in state (presence to absence) and/or an action (removal) relative to the weapon normally disposed within the sensor-enabled holster. The detected change in state and/or action may be reported to a radio 137 via its short-range transceiver, which may forward the state change to the dispatch center 131 or the workflow server 102. In some examples, the sensor-enabled holster may also detect whether the first responder's hand is resting on the weapon even if it has not yet been removed from the holster and provide such information to portable radio 137.

In some examples, a sensor 138 may comprise a biometric sensor (e.g., a biometric wristband) for tracking an activity of the user or a health status of a user, and may include one or more movement sensors (such as an accelerometer, magnetometer, and/or gyroscope) that may periodically or intermittently provide to a radio 137 indications of orientation, direction, steps, acceleration, and/or speed, and indications of health such as one or more of a captured heart rate, a captured breathing rate, and a captured body temperature of the user, for example accompanying other information. This information may be reported to a radio 137 which may forward the information to the dispatch center 131 and/or the workflow server 102.

In some examples, a sensor 138 may comprise an accelerometer to measure acceleration. Single and multi-axis models are available to detect magnitude and direction of the acceleration as a vector quantity, and may be used to sense orientation, acceleration, vibration shock, and falling. The accelerometer may determine if an officer is running. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing. This information may be reported to a radio 137 which may forward the information to dispatch center 131 and/or the workflow server 102.

In some examples, a sensor 138 may comprise a heart rate sensor that uses electrical contacts with the skin to monitor an electrocardiogramal of its wearer, or may use infrared light and imaging device to optically detect a pulse rate of its wearer, among other possibilities. This information may be reported to a radio 137 which may forward the information to the dispatch center 131 and/or the workflow server 102.

In some examples, a sensor 138 may comprise a breathing rate sensor 138 to monitor breathing rate. The breathing rate sensor may include use of a differential capacitive circuits or capacitive transducers to measure chest displacement and thus breathing rates. In other examples, a breathing sensor may monitor a periodicity of mouth and/or nose-exhaled air (e.g., using a humidity sensor, temperature sensor, capnometer or spirometer) to detect a respiration rate. Other possibilities exist as well. This information may be reported to a radio 137 which may forward the information to the dispatch center 131 and/or the workflow server 102.

The dispatch center 131 may comprise, and/or may be part of, a computer-aided-dispatch center (sometimes referred to as an emergency-call center or public-safety answering point), that may be manned by an operator providing any suitable dispatch operations. For example, the dispatch center 131 may comprise a graphical user interface that provides the dispatch operator any suitable information about public-safety officers. As discussed above, some of this information originates from sensors 138 providing information to radios 137, which forwards the information to the RAN 135 and ultimately to the dispatch center 131.

In a similar manner, information about public-safety officers may be provided to the workflow server 102. This information may originate from the sensors 138 providing information to the radios 137, which forwards the information to the RAN 135 and ultimately to the workflow server 102 via the public safety core network 132 and the gateway 133. For example, a sensor 138 comprising a gun-draw sensor may send an indication to the workflow server 102 that a gun has been drawn. This may serve as a “trigger” for the workflow server 102 to initiate a particular “action”, for example, notifying surrounding officers (for example on a particular talkgroup) by having their radios 137 provide an alarm indicating the triggering event. Thus, the workflow server 102 may provide instructions to any sensor 138 or radio 137 by sending an “action” to a sensor 138 in response to a trigger being received.

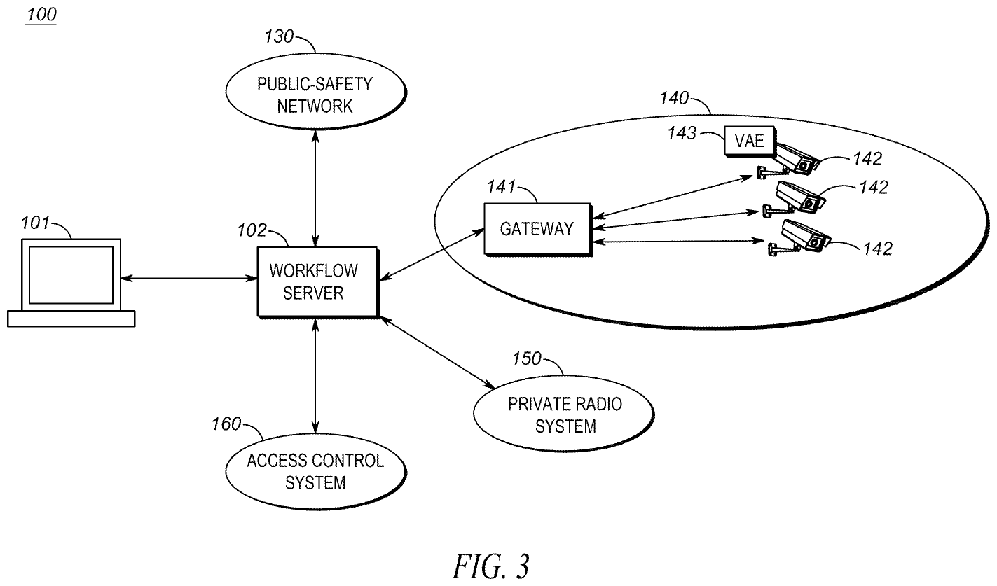

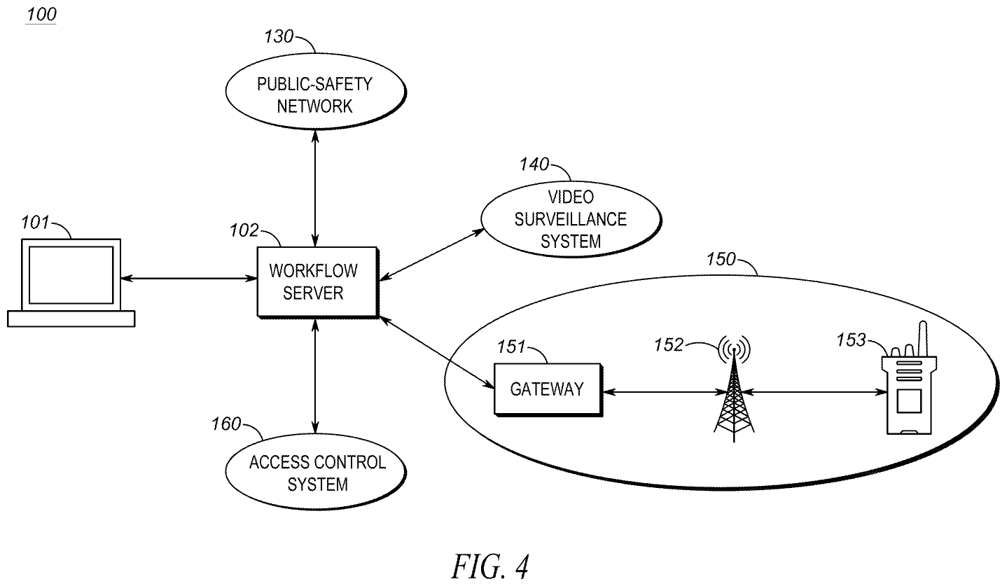

FIG. 3 illustrates a security ecosystem capable of configuring and automating workflows. In particular, FIG. 3 shows the security ecosystem 100 with an expanded view of the video surveillance system 140. As shown, the video surveillance system 140 comprises a plurality of image sensors and/or cameras 142 and the gateway 141.

Cameras 142 may be fixed or mobile, and may have pan/tilt/zoom (PTZ) capabilities to change their field of view. The cameras 142 are generally understood to comprise image sensors and hence may also be referred to as images sensors. Cameras 142 may also comprise circuitry configured to serve as a VAE 143 (only one of which is depicted in FIG. 3, though it is understood that any camera 142 may comprise circuitry configured to serve as a VAE 143). The VAE 143 comprises a software engine that analyzes analog and/or digital video. The engine configured to “watch” video and detect pre-selected objects such as license plates, people, faces, automobiles. The software engine may also be configured to detect certain actions of individuals, such as fighting, loitering, crimes being committed, . . . , etc. The VAE 143 may contain any of several object/action detectors. Each object/action detector “watches” the video for a particular type of object or action. Object and action detectors can be mixed and matched depending upon what is trying to be detected. For example, an automobile object detector may be utilized to detect automobiles, while a fire detector may be utilized to detect fires.

The gateway 141 may comprise an Avigilon™ Control Center running Avigilon's Access Control Management software. The gateway 141 is configured to run any suitable Application Program Interface (API) to provide communications between any cameras 142 and the workflow server 102.

FIG. 4 illustrates a security ecosystem capable of configuring and automating workflows. In particular, FIG. 4 shows the security ecosystem 100 with an expanded view of the private radio system 150. As shown, the private radio system 150 comprises the gateway 151, system infrastructure 152, and at least one radio 153. Communications from the radio 153 to the workflow server 102 passes through the system infrastructure 152, the gateway 151, and ultimately to the workflow server 102.

The gateway 151 may comprise an Avigilon™ Control Center running Avigilon's Access Control Management software. The gateway 151 is configured to run any suitable Application Program Interface (API) to provide communications between any of the system infrastructure 152 and the workflow server 102.

The system infrastructure 152 comprises any suitable equipment to provide wireless communications to and from the radio 153. The system infrastructure 152 may comprise Motorola Solutions MOTOTRBO™ equipment, such as an SLR Series Repeater (e.g., SLR 1000, SLR 5000, or SLR8000 repeater) configured to provide two-way radio service to radio 153.

Although only a single radio 153 is shown in FIG. 4, any suitable number of radios 153 may be present within the private radio system 150. Each radio 153 may comprise a MOTOTRBO™ two-way radio (such as a Motorola Solution XPR 5000 Series radio) with digital technology providing integrated voice and data communication.

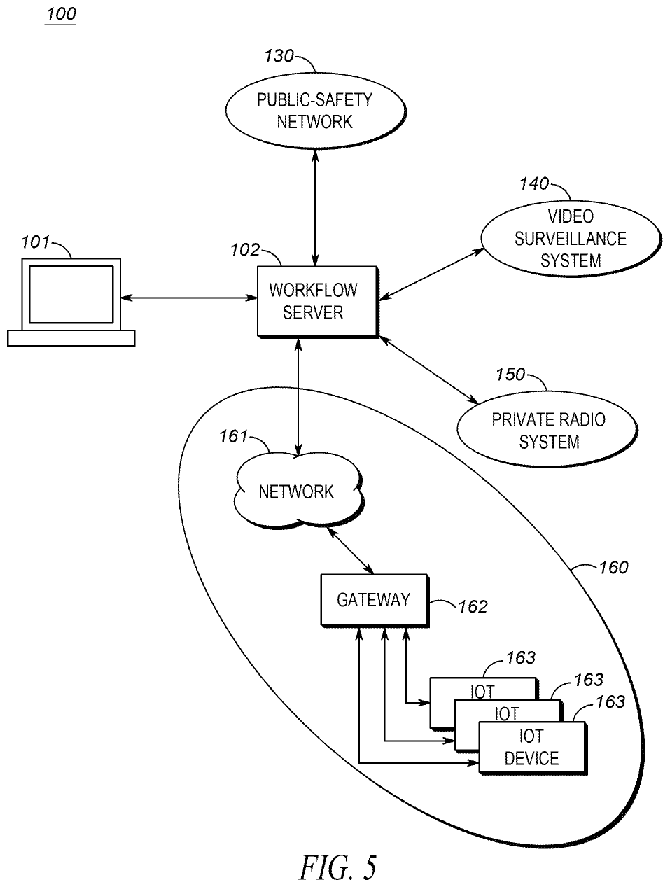

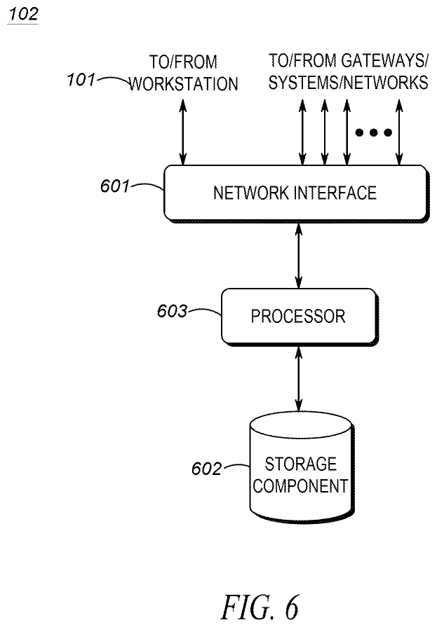

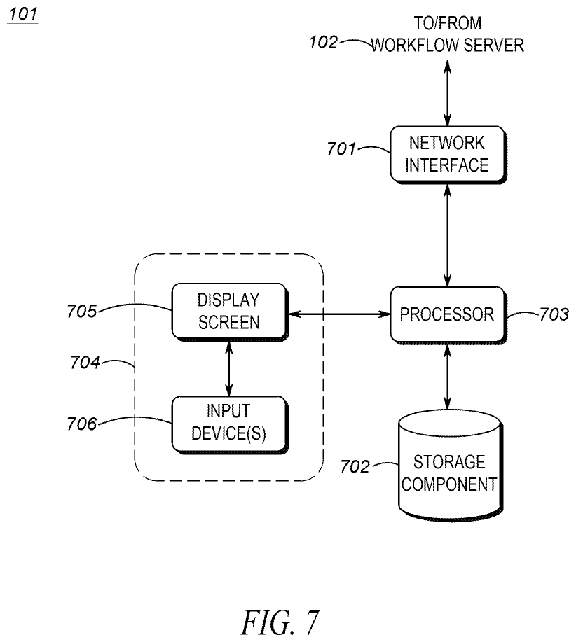

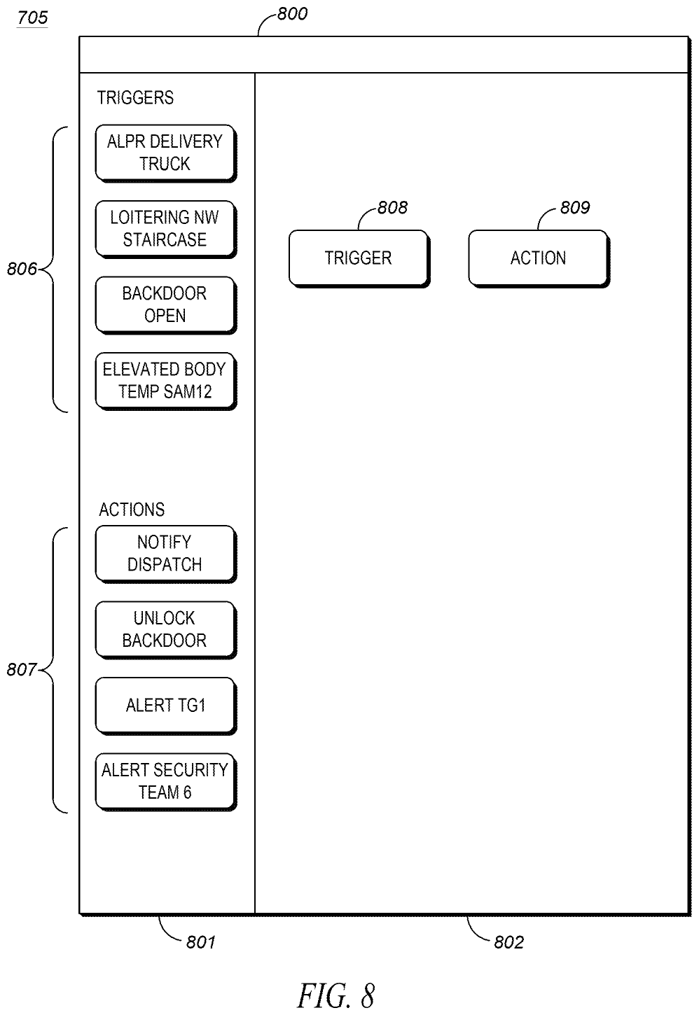

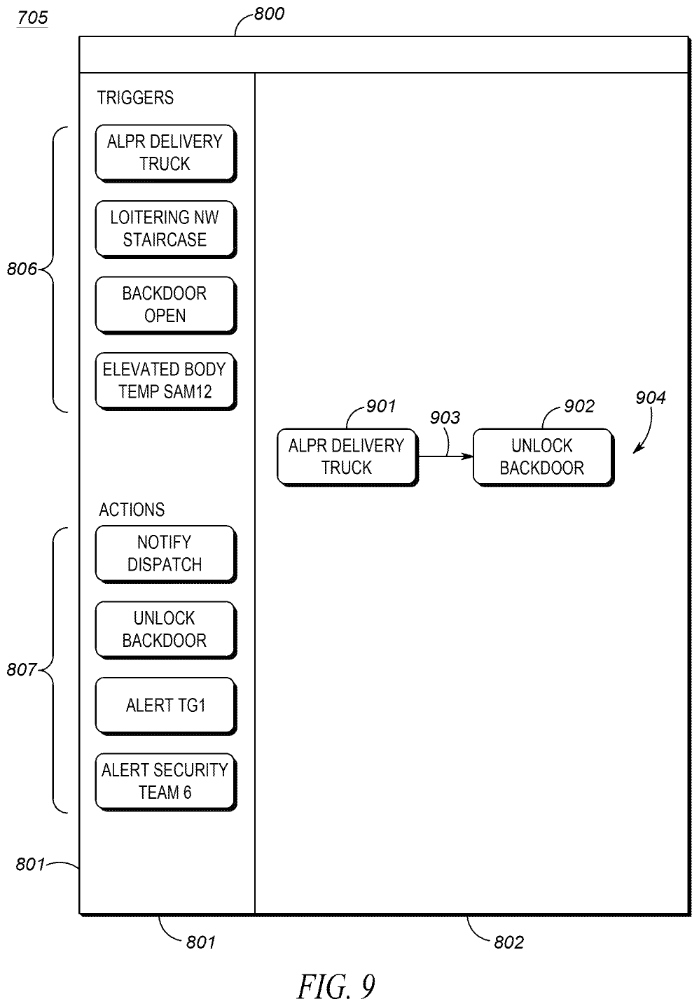

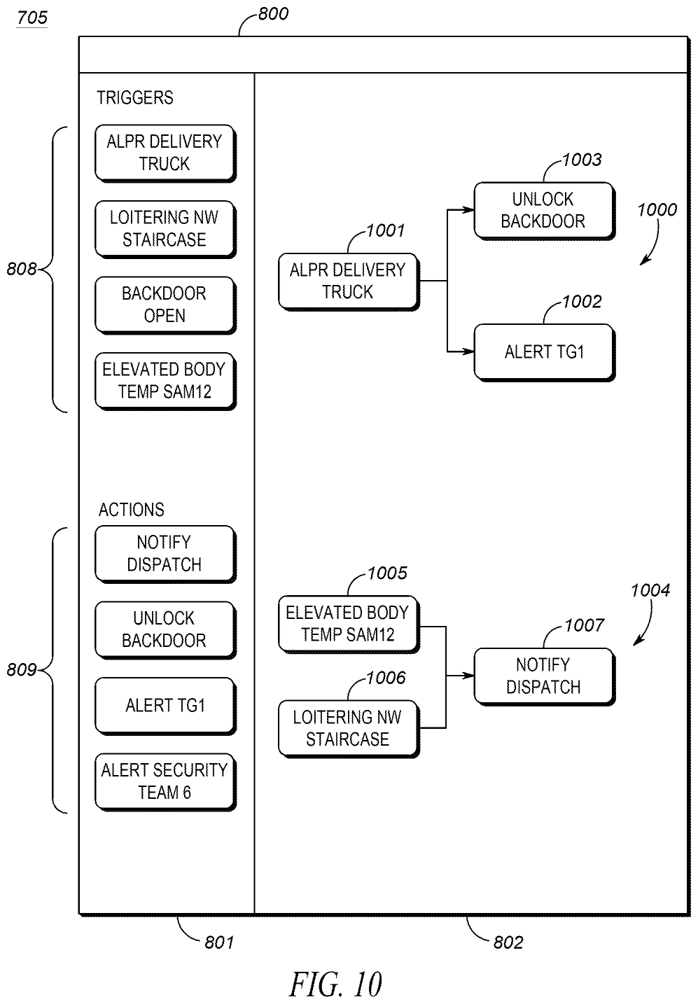

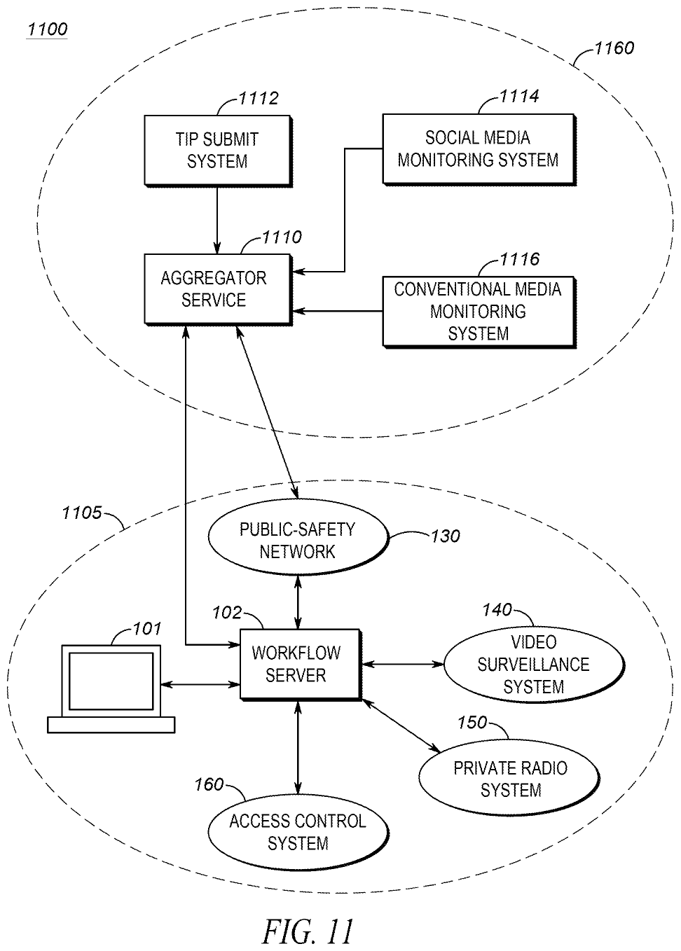

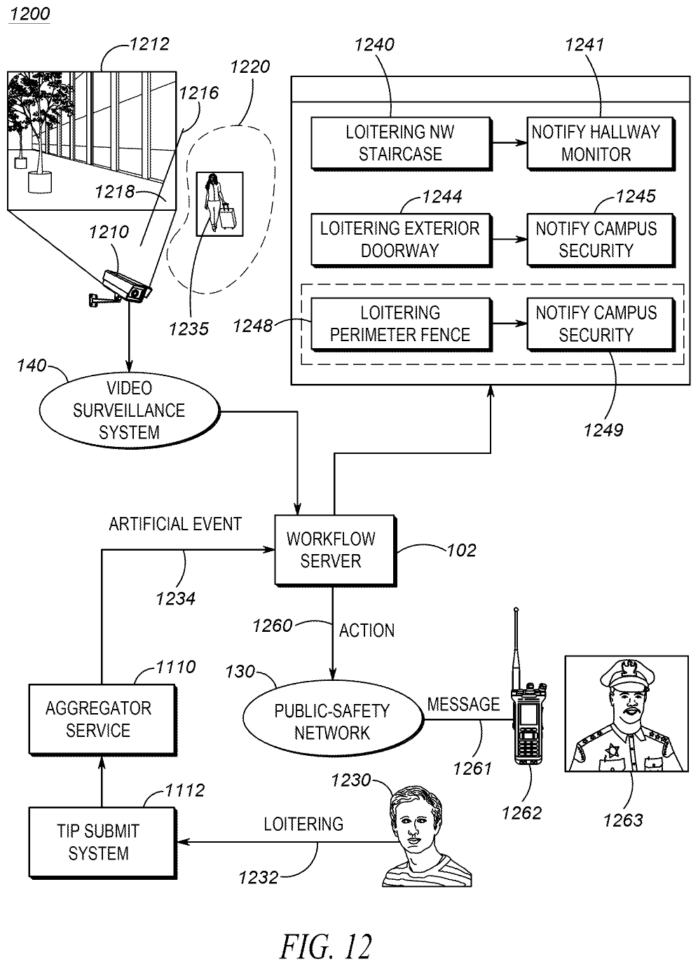

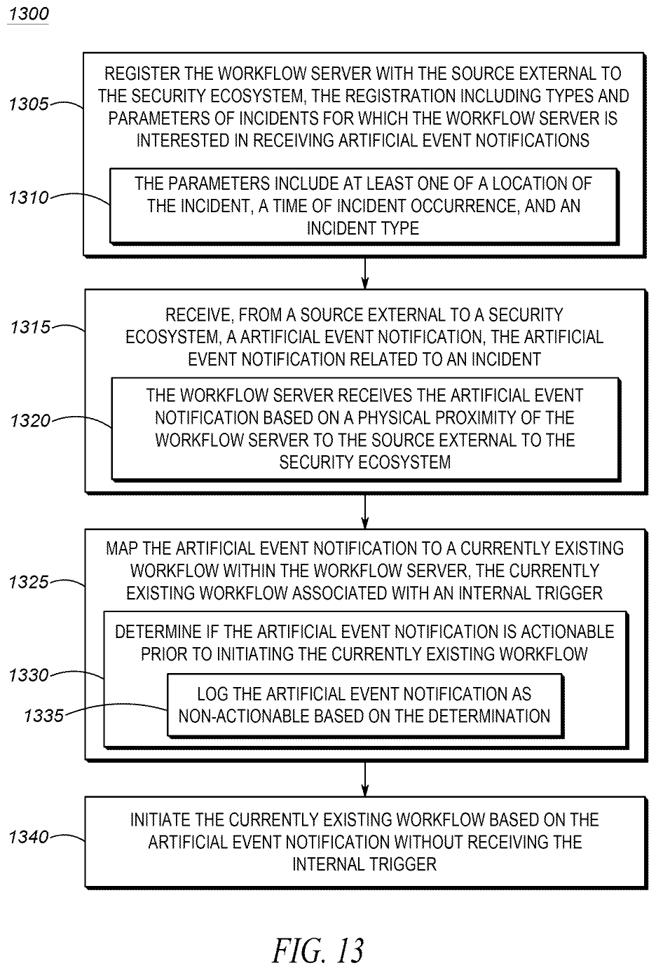

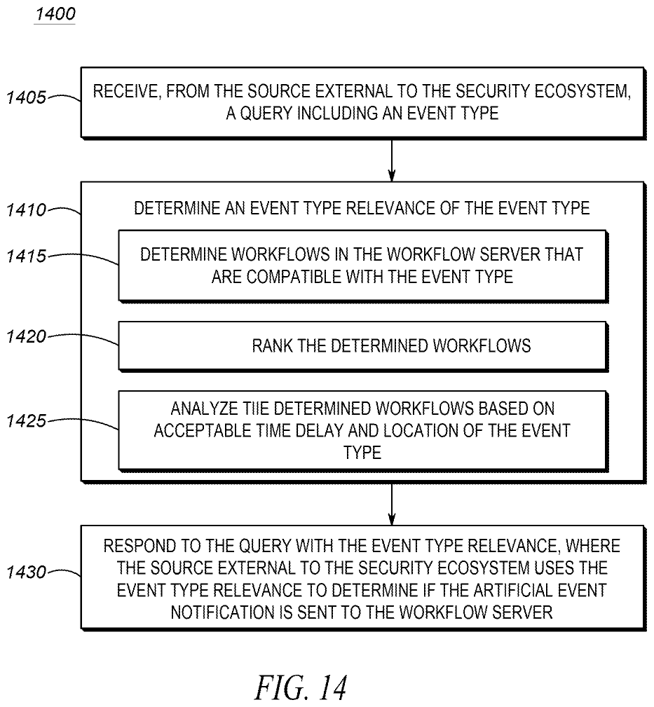

FIG. 5 illustrates a security ecosystem capable of configuring and automating workflows. In particular, FIG. 5 shows the security ecosystem 100 with an expanded view of the access control system 160. As shown, the access control system 160 comprises a gateway 162 and a plurality of IoT devices 163 coupled to the gateway 162. Data passed from the workflow server 102 to the IoT devices 163 passes through the network 161, the gateway 162 and ultimately to the IoT device 163. Conversely, data passed from the IoT devices 163 to the workflow server 102 passes through the gateway 162, the network 161, and ultimately to the workflow server 102.

The IoT devices 163 may comprise devices that control objects, doors, windows, sensors, and the like. Any particular suitable communication protocol (e.g. an IoT protocol) may be used for each IoT device. For example, various proprietary protocols such as DNP, Various IEC **** protocols (IEC 61850 etc., . . . ), bacnet, EtherCat, CANOpen, Modbus/Modbus TCP, EtherNet/IP, PROFIBUS, PROFINET, DeviceNet, . . . , etc. can be used. Also a more generic protocol such as Coap, Mqtt, and RESTfull may also be used.

The gateway 162 may comprise an Avigilon™ Control Center running Avigilon's Access Control Management software. The gateway 162 is configured to run any suitable Application Program Interface (API) to provide communications between any IoT device 163 and the workflow server 102.

The network 161 may comprise one of many networks used to transmit data, including, but not limited to, a network employing one of the following protocols: conventional, or trunked LMR standard or protocol such as ETSIDMR, a 25 standard defined by the APCO, TETRA, or other LMR radio protocols or standards; LTE protocol, LTE-Advance protocol, or 5G protocol including multimedia broadcast MBMS or SC-PTM protocol (including, but not limited to an OMA-PTT OMA-PoC), a VoIP protocol, an LTE Direct or LTE Device to Device protocol, or a PolP protocol, a Wi-Fi protocol for example operating in accordance with an IEEE 802.11 standard (e.g., 802.11a, 802.11b, 802.11g) or a WiMAX protocol for example operating in accordance with an IEEE 802.16 standard.

FIG. 6 is a block diagram of the workflow server 102 of FIG. 1. As shown, the workflow server 102 comprises a network interface 601, a storage component 602 (e.g. as depicted a database, but may comprise any suitable memory and/or storage component), and a processor 603. The processor 603 is understood to include any suitable logic circuitry.

The network interface 601 includes any suitable components for communicating with other suitable components of the system 100, in particular, as depicted, to the workstation 101, the gateways 133, 141, 151, 162 of the networks and systems 130, 140, 150, 160, and the like. Components of the network interface 601 include any suitable processing, modulating, and transceiver components that are operable in accordance with any one or more standard or proprietary wireless interfaces, wherein some of the functionality of the processing, modulating, and transceiver components may be performed by means of the processor 603 through programmed logic such as software applications or firmware stored on the storage component 602 (e.g., standard random access memory) or through hardware. The network interface 601 may include any suitable wired or wireless network interfaces, including, but not limited to, Ethernet interfaces, T1 interfaces, USB interfaces, IEEE 802.11b interfaces, IEEE 802.11g interfaces, and the like.

The processor 603 may comprise a digital signal processor (DSP), general purpose microprocessor, a programmable logic device, or application specific integrated circuit (ASIC), and the like, and is generally configured to receive triggers from various gateways, systems, and networks (e.g. of the system 100). The processor 603 is further configured to execute (or cause to be executed) a particular action for a trigger that is received. More particularly, when the processor 603 receives a trigger from any network or system, the processor 603 may access the storage component 602 to determine an action for the particular trigger. Once an action has been determined, the processor 603 will execute the action, or cause the action to be executed. In order to perform the above, the processor 603 may executes an instruction set/software (e.g., Motorola Solution's Command Central™ software suite comprising the Orchestrate™ platform) which may be stored at the storage component 602.

The storage component 602 may comprises standard memory (such as Random Access Memory (RAM), Read Only Memory (ROM), and the like) and serves to store associations between triggers and actions. Examples of various triggers and actions are illustrated in in Table 1, below.

TABLE 1
Associations Between Triggers and Actions.

| Trigger | Action |
|---|---|
| Warehouse back door opened | Pan camera “342” to point at door |
| Man-Down sensor activated for | Notify dispatch center via emergency |
| Officer Smith | text message |
| ALPR for delivery truck | Open back gate |
| . . . etc. | . . . etc. |

FIG. 7 is a block diagram of the workstation 101 of FIG. 1 utilized to create a workflow. As shown, the workstation 101 comprises a network interface 701, a storage component 702, a processor 703, and a graphical user interface (GUI) 704.

The network interface 701 includes any suitable components for communicating with other suitable components of the system 100, in particular, as depicted, to the workflow server 102. Components of the network interface 701 include any suitable processing, modulating, and transceiver components that are operable in accordance with any one or more standard or proprietary wireless interfaces, wherein some of the functionality of the processing, modulating, and transceiver components may be performed by means of the processor 703 through programmed logic such as software applications or firmware stored on the storage component 702 (e.g., standard random access memory) or through hardware. The network interface 701 may include any suitable wired or wireless network interfaces, including, but not limited to, Ethernet interfaces, T1 interfaces, USB interfaces, IEEE 802.11b interfaces, IEEE 802.11g interfaces, and the like.

Processor 703 may comprise a DSP), general purpose microprocessor, a programmable logic device, or an ASIC and may be configured to execute Motorola Solution's Orchestrate™ and Ally™ dispatch and incident management software which may be stored at the storage component 702. The execution of such software may allow users of the GUI 704 to create workflows (i.e., actions and their associated responses) by receiving user inputs at the GUI 704 that define various triggers and their associated actions, which will ultimately be uploaded to the workflow server 102 and stored in the storage component 602.

The storage component 702 may comprise standard memory (such as RAM, ROM, and the like) and serves to store instructions as software. Particularly, Motorola Solution's Orchestrate™ and Ally™ dispatch and incident management software is may be stored at the storage component 702.

The GUI 704 generally provides a man/machine interface for receiving an input from a user and displaying information. For example, the GUI 704 may provide a mechanism of conveying (e.g., displaying) user-created workflows. Thus, the GUI 704 may also provide a mechanism for a user to input workflows into a displayed form. In order to provide the above features (and additional features), the GUI 704 may include any combination of a display screen 705 (e.g., a computer screen, which may include a touch screen, a monitor, and the like) and any suitable combination of one or more input devices 706 (e.g. a keyboard and mouse combination).

FIG. 8 illustrates the creation of a workflow. More particularly, FIG. 8 illustrates a dashboard 800 rendered at the display screen 705 utilized for the creation of workflows. As depicted, the dashboard 800 consists of the following main components:
a selection panel 801 (e.g. on a left-hand side), which lists available triggers 806 and actions 807;
a workspace 802, which comprises a large area in the middle of the dashboard 800 used to create workflows that define the connections between triggers and actions. Each workflow in the workspace is displayed as a separate field 808, 809 with an outline and a title. As shown in FIG. 8, two fields 808, 809 are shown, one labeled “trigger” and another labeled “action”.

While the dashboard 800 is depicted in a particular configuration, the dashboard 800 may have any suitable configuration; for example, the selection panel 801 may be on a right-hand side, a top side or a bottom side relative to the workspace 802.

The triggers 806 represent the events originating from various sensors, software, and devices within the security ecosystem 100. The actions 807 represent the possible responses to the triggers that may be implemented via any suitable various sensors, software, and devices within the security ecosystem 100, including, but not limited to, the radios 137, 153.

After a workflow is deployed (i.e., uploaded to the workflow server 102), its actions activate when the triggers occur. Triggers and actions appear on the workspace after they are dragged and dropped from the triggers 806 and actions 807 tabs respectively. For example, as depicted, the field 808 represents a trigger 806 that may have been dragged and dropped to the workspace 802 and the field 809 represents an action 807 that may have been dragged and dropped to the workspace 802. Connecting the triggers and actions on the workspace (as described below) will create a workflow.

The triggers 806 and the actions 807 are generally stored at the storage component 702 and represent integrations across multiple products. In other words, triggers 806 and the actions 807 comprise triggers and actions for any suitable components available in the security ecosystem 100. This includes cameras, sensors, IoT devices, radios, . . . , etc. As administrators add additional technology pieces to the security ecosystem 100, those pieces may be automatically made available for workflow creation as discussed herein.

In order to associate a trigger 806 with an action 807 in the workspace 802, a user selects a trigger 806 from all possible triggers 806, and drags and drops it onto workspace 802, as represented by the field 808. The user then selects an action 807 for the trigger 806 that is in the workspace 802, and drags and drops it onto workspace 802. Once in the workspace 802, a trigger 806 may be referred to as an trigger node, and an action 807 may be referred to as an action node. In order to associate the trigger 806 with the action 807, they are connected. To connect a trigger node to an action node, a user may click an end of the trigger node (e.g. that is closest to the action node) and drag a line to the action node, or vice versa. However, any suitable process for connecting nodes is within the scope of the present specification.

As shown in FIG. 9, which depicts the dashboard 800 in use, a trigger “ALPR delivery truck” 901 has been associated with an action “unlock back door” 902 by dragging a line 903 between the two, thereby forming a workflow 904. While only one trigger 901 and one action 902 is depicted in the workflow 904, the workflow 904 may comprise any suitable number of triggers (e.g. a trigger group) and any suitable numbers of associated action (e.g. an action group). Hence, if any of the triggers within a trigger group occurs, the workflow 904 is initiated causing the action to be executed. For example, as depicted ALPR stands for automated license plate reader, which may be one of the IoT devices 163; as such, according to the workflow 904, when automated license plate reader of the access control system 160 “reads” a license plate of a delivery truck (e.g. the trigger 901), an associated backdoor (e.g. of a warehouse) is opened; such a backdoor may also comprise one of the IoT devices 163. While note depicted, a memory in the system 100 may also store a list of license plates for which the backdoor is to be opened and the trigger 901 may include comparing a number of the license plate that is read with license plates in such a list, such that the backdoor is opened only when the license plate is on the list.

Furthermore, it is understood that the system 100 may comprise a plurality of IoT devices 163 that are automated license plate reader, and that the trigger 901 may be for a particular automated license plate reader; as such, while not depicted, the actions 807 may include respective “ALPR” actions 807 for other automated license plate reader. Similarly, it is understood that the system 100 may comprise a plurality of IoT devices 163 that are backdoors, and that the action 902 may be for a particular backdoor; as such, while not depicted, the actions 807 may include respective “Unlock Backdoor” actions 807 for other backdoors.

For example, as depicted the triggers 806 include a trigger 806 for detecting loitering at a particular “North West” (e.g. NW) staircase of a particular building (e.g. “Loitering NW Staircase”) that may be detected using a VAE 143 of one or more cameras 142 and the like. The triggers 806 further includes a trigger 806 for detecting whether a particular backdoor is open (e.g. “Backdoor Open”) that may be detected using a VAE 143 of one or more cameras 142 and/or an open/closed sensor on the backdoor and the like. The triggers 806 further includes a trigger 806 for detecting whether a particular individual, for example a first responder and/or police officer and/or security guard having an identifier “SAM12” has an elevated body temperature (e.g. “Elevated Body Temp SAM12”) that may be detected using a biometric sensor of one or more sensors 138 and the like.

For example, as depicted the actions 807 include an action 807 for notifying a first responder and/or police and/or security dispatch (e.g. “Notify Dispatch”) such as the dispatch center 131. The actions 807 further includes an action 807 for alerting a particular talkgroup identified by the identifier TG1 and/or Talkgroup #1 (e.g. “Alert TG1”) such as a particular talkgroup of the radios 137 (and/or the radios 153). The actions 807 further includes an action 807 for alerting a particular security team identified by the identifier Security Team 6 (e.g. “Alert Security Team 6”) which may be associated with a particular group of the radios 137 (and/or the radios 153) and which may, or may not, be associated via a talkgroup.

However, the triggers 806 and actions 807 may include any suitable triggers and actions, which may be dragged and dropped, and the like, into the workspace 802, and associated with each other to generate workflows.

As illustrated in FIG. 10, a single trigger may be associated with multiple actions in a workflow. Thus, in an illustrated workflow 1000, a trigger 1001 of “ALPR delivery truck” may be associated with an action 1003 of “Unlock Back Door” 1003 as well as associated with an action 1002 of “Alert TG 1”. When the workflow 1000 is uploaded to the workflow server 102, and the automatic license plate detects a delivery truck, workflow server 102 will cause both the back door to unlock and an alert to be sent on Talkgroup #1.

In a similar manner multiple triggers may be associated with a single action. Thus, in an illustrated workflow 1004, both a trigger 1005 of “Elevated Body Temp SAM 12” and a trigger 1006 of “Loitering NW Staircase” will cause an action 1007 of “Notify Dispatch” 1008. When the workflow 1004 is uploaded to the workflow server 102, the workflow server 102 notifies the dispatch center when either a police officer (and the like) identified by the identifier “SAM 12” has an elevated body temperature (e.g. above a threshold body temperature) or when loitering is detected in the NW staircase.

As mentioned above, a problem arises when there are possible sources of triggers that are external to the security ecosystem (e.g. not under the control of the workflow server, etc.). The external sources have no idea what workflows have been created within the workflow server. Furthermore, the external sources should not be allowed to cause workflows to initiate without some analysis of the event being associated with an incident and determination of the appropriate workflow, if any that should be initiated.

In order to address this problem, an aggregator service is provided that receives inputs from sources external to the security ecosystem. The aggregator service sends artificial events into the workflow server. The events are called artificial events, because they are not real triggers. The workflow server may receive these artificial events and determine first, if they require that a workflow is initiated, and second which workflow is to be initiated.

FIG. 11 is an example of a communications system 1100 that may implement the aggregator service to initiate a workflow based on an artificial event. The communications system described in FIG. 11 is essentially the same as that described with respect to FIG. 2 with the exception that an aggregator service 1110 is provided. The aggregator service aggregates potential events from other systems, as will be described in further detail below. It should be further understood that the aggregator system may be provided as an aid to connecting the external systems to the workflow server 102. In some implementations, each external system may directly interface with the workflow server. Example devices that could be used to implement the aggregator service or any of the external systems are described with respect to FIGS. 6 and 7.

As shown, the communications system 1100 includes a workflow server 102 operating within a security ecosystem 1105. All elements within the security ecosystem 1105 are generally under the control of an enterprise. For example, the enterprise may directly control the video surveillance system 140, the private radio system 150, and the access control system 160. Although the enterprise may not directly control the public safety network 130, there are established relationships between the two. Furthermore, the public safety network generally does not send triggers into the workflow server, but rather is the subject of receiving request to perform actions. In other words, the public safety network generally does not cause workflows to be initiated.

The communications system 1100 may also include several systems that are external to the security ecosystem 1105. These sources of artificial events may be referred to as sources external to the security ecosystem 1160. As described above, in some implementations, an aggregator service 1110 is used to gather incident information from the external sources. However, this may be for ease of implementation only. In some implementation each external source may directly connect the workflow server 102.

Tip Submit system 1112 may be one example of a source external to the security ecosystem 1105. The Tip Submit system may be a system that allows members of the public to report crimes, suspected crimes, or general suspicious behavior. Some tip submit systems may be operated by the government (e.g. CityProtect™, Crime Stoppers™, etc.). In other cases, the tip submit system may be privately owned (e.g. Ring Neighbors™, etc.). What should be understood is that the tip submit system may receive information that is not directly available from sensors located within the security ecosystem.

Social media monitoring system 1114 may be another example of a source external to the security ecosystem 1105. The social media monitoring system may be a system that monitors social media (e.g. Meta™, X™, TikTok™, etc.) to detect incidents/events that may affect the enterprise. For example, in recent news it was shown that social media was used to coordinate massive shoplifting incidents openly. This is the type of information that the sensors within the security ecosystem 1105 would not be able to detect. If an event cannot be detected, a workflow to handle the event cannot be initiated.

Conventional media monitoring system 1116 is yet another example of a source external to the security ecosystem 1105. The conventional media monitoring system may monitor traditional media (e.g. television, radio, etc.) for events that may impact the enterprise. For example, there may be reports of large crowds (e.g. potential rioting, etc.) gathering nearby the enterprise. These crowds may not be detected by the sensors within the security ecosystem, as the crowds may not yet have entered the field of view/detection area of those sensors. Again, if an event cannot be detected, a workflow to handle the event cannot be initiated.

FIG. 11 also shows a connection between the public safety network 130 and the aggregator service. Although the public safety network may be within the security ecosystem, some information provided by public safety may be considered outside of the security ecosystem, because it is provided to the public generally, without being target to any individual. For example, the information might not be sent directly from the public safety network to the workflow server in the form of a trigger.

For example, public safety network 130 may have information contained in evidence databases, body worn camera footage, most wanted lists, pictures of missing children, etc. that may be shared with the public. This information would not necessarily constitute information associated with a trigger. The aggregator service may receive this information and determine if an artificial event should be sent to the workflow server.

In operation, the aggregator service 1110 may receive information from any of the external systems (e.g. the tip submit system 1112, the social media monitoring system 1114, the convention media monitoring system 1116, the public safety network 130, etc.) and determine if an incident that might affect the enterprise is occurring. For example, social media is monitored and it is determined that a shoplifting flash mob is being organized. In some cases, this is sufficient for the aggregator service to generate an artificial event and send it to the workflow server. As will be explained in further detail with respect to FIG. 12, the receipt of an artificial event does not necessarily cause any workflow to be initiated. The workflow server may receive the artificial event and make the determination, based on information included in the event, as to which, if any, workflow will be initiated.

In some cases, the artificial event may be sent to the workflow server 102 based on information received from multiple external systems. For example, there may be talk of a flash mob-shoplifting event detected by the social media monitoring system 1114, but no specific location could be determined. The conventional media monitoring system 1116 may detect crowds forming near the enterprise that is operating communications system 1100. The combination of this information may cause the aggregator service 1110 to send an artificial event to the workflow server.

Regardless of how detected, what should be understood is that the possibility of an incident occurring is detected by a source external to the security ecosystem 1160. The potential (or actual) incident, and information related to the incident is sent to the workflow server 102 in the form of an artificial event. The artificial event includes information about the incident. The workflow server then makes a decision, based on this information, if a workflow will be initiated.

FIG. 12 illustrates an example environment 1200 in which reception of an artificial event, selecting a currently existing workflow based on the artificial event, and initiating the workflow is depicted. The environment may include workflow server 102, public safety network 130, video surveillance system 140, aggregator system 1110, and tip submit system 1112. Each of these systems may operate as described below.

The video surveillance system 140 may be coupled to a camera 1210. The camera may have a field of view 1212. In this example, assume the field of view of the camera is the exterior of a school building. The exterior of the school building may include a fence 1216. The field of view of the camera may include a portion 1218 of the fence. There may be another portion 1220 of the fence that is outside the field of view of the camera. For example, a person may be in the portion of the fence that is outside the field of view, such that the camera cannot detect if anyone is there. As should be clear, if the camera is not able to see something in its field of view, it is not possible for it to cause a trigger to occur. The camera can only cause triggers for events within the field of view.

In operation, a civilian 1230 may be in the vicinity of environment 1200 and notices a person 1235 loitering near the vicinity of fence 1216. As shown, the person is loitering in an area 1220 that is outside of the field of view of camera 1210. As such, the camera is not able to detect the loitering event, because it cannot see it. No detection by a sensor within the security ecosystem means that no workflow will be initiated.

The civilian 1230 may report a loitering tip 1232 to the tip submit system 1112. As part of the tip submission, the civilian may include the time of day the loitering person was noticed, the location where the loitering person was seen, a description of the loitering person, etc. In general, any information available about the potential incident is provided to the tip submit system. In many cases, the tip submit system may be connected to the public safety network 130. However, the mere submission of the tip may not cause the public safety network to take any action. As should be clear, the tip submit system, even if directly connected to the workflow server 102, cannot directly cause a trigger to be received by the workflow server, because it is a source external to the security ecosystem.

The aggregator service 1110 may receive information about the loitering tip 1232 from the tip submit system. The aggregator system may then take the data associated with the tip (e.g. loitering, time of day, location, description, etc.) and provide this information in the form of an artificial event 1234 that is sent to the workflow server 102. The artificial event is referred to as artificial, because it is not an actual trigger for the workflow server. The information included in the artificial event is used to determine if a workflow is initiated, even though no internal trigger was received.

Initially, the workflow server 102 may look at information in the artificial event to determine what type of incident is occurring. For example, the artificial event may indicate the potential event is loitering. The workflow server may determine that there are three currently existing workflows related to loitering. The first workflow includes a trigger of loitering in the NW staircase 1240. The corresponding action for that trigger is to notify a hallway monitor 1241. In this example, because the loitering may be occurring inside the school building, the workflow indicates an internal resource should be used to respond.

The second workflow includes a trigger of loitering by an exterior doorway 1244. The corresponding action of that workflow is to notify campus security 1245. For example, because this may be a threat from someone on school grounds, campus security may have authority to take action. The third workflow may include a trigger of loitering by a perimeter fence 1248. The corresponding action of that workflow is to notify the police department 1249. For example, the police may be notified because campus security may have no authority to confront someone not yet on campus grounds.

The workflow server 102 may analyze the information sent in the artificial event 1234 to determine which, if any, of the workflows should be initiated. For example, the artificial event may have included a location where the incident occurred. In this example, the location provided may indicate that it was nearby the perimeter fence. The workflow server may then determine that the location provided is most similar to the trigger of loitering by the perimeter fence 1248.

The workflow server 102 may then initiate the workflow. In this case, the workflow action is to notify the police department 1249. The workflow server 102 may initiate the action by sending the action 1260 to the public safety network 130. The public safety network may then send a message 1261 to a device 1262 associated with a public safety officer 1263 to respond to the loitering incident. What should be noted is that at no point was the loitering by the perimeter fence trigger 1248 ever actually received from a sensor within the security ecosystem.

It should also be noted that the workflow server 102 is responsible for determining if any workflow is initiated at all. For example, the artificial event 1234 may have included a location of the incident that was not nearby the school. As such, the loitering incident may be irrelevant to the school. As such, no workflow would be initiated.

It should further be noted that although the artificial event notification has been described as causing a workflow to be initiated, the artificial event notification may also have the effect of disabling a workflow. For example, consider a case where there is a parade expected to pass by the fence 1216 and as such it is expected that people will be lined up along the parade route to watch the parade. Such behavior could be confused with loitering. An artificial event notification could be sent to the workflow server 102 indicating the parade event. The workflow server may then temporarily disable the loitering trigger/workflow for the area around the fence. In a similar fashion, many triggers may have threshold values that determine when the workflow is actually initiated. An artificial event notification may cause the workflow server to modify such a threshold value.

Although FIG. 12 was described with respect to a school campus, it should be understood that the techniques described herein are not so limited. What should be understood is that a system/sensor external to the security ecosystem provides information related to a potential incident. The external system/sensor is completely unaware of triggers/actions/workflows provided by the workflow server. The external system/sensor provides information to the workflow server via the artificial event. The workflow server then determines which workflow, if any, is triggered. No internal trigger of the workflow to be imitated (if any) is received from within the security ecosystem.

FIG. 13 is an example flow chart 1300 describing receiving an artificial event and initiating a workflow according to techniques described herein. In block 1305, the workflow server registers with the source external to the security ecosystem. The registration includes types and parameters of incidents for which the workflow server is interested in receiving artificial event notifications. As explained above, the aggregation service may be a source external to the security ecosystem (e.g. not under the control of the enterprise, etc.). The workflow server may register with the source external to the security ecosystem to let the external source know that the workflow server desires to receive artificial event notifications that may pertain to the security ecosystem. As part of the registration, the workflow server may specify what details related to possible incidents it wishes to receive.

Although block 1305 describes the workflow server registering with the source external to the security ecosystem, it should be understood that this is only one possible implementation. In a different implementation, the source external to the security ecosystem may register with the workflow server. As will be explained further with respect to FIG. 14, in some implementations, the source external to the security ecosystem may query the workflow server to determine if an artificial event notification will be sent.

In block 1310, the parameters include at least one of a location of the incident, a time of incident occurrence, and an incident type. Location of the incident may determine if the incident is of interest to the workflow server. For example, if the location of the incident is sufficiently far enough away from the enterprise, there may be no need for the workflow server to take any action, such as initiating a workflow.

A time of incident occurrence may be used in a similar fashion. For example, if an incident occurred a long enough time ago, there may be no need to initiate a workflow. For example, if a civilian reports a loitering incident that occurred yesterday, there would be no reason to initiate a workflow to respond to the loitering, as it is highly unlikely that the person who was loitering is still there the next day. Although the information may be of historical value, there is no need for an instant response by initiating a workflow.

An incident type may be used in a similar fashion. In some cases, the workflow server may only be interest in certain types of incidents. For example, loitering, assault, theft, etc. These may be the only types of incidents the workflow server cares about. The source external the security ecosystem may provide artificial events for any number of different types of incidents. For example, the incident may be a person is detected jaywalking on a street near the enterprise. By including the incident type in the artificial event notification, the workflow server is able to determine if it is the type of incident for which a workflow will be initiated.

Although the previous example is presented in terms of the decision on initiating a workflow being left to the workflow server, in some implementations, the workflow server may specify the criteria under which an artificial event notification is sent (e.g. incident types, proximity to enterprise, time of occurrence, etc.). In such an implementation, the source external to the security ecosystem is able to determine by itself which artificial events will be sent to the workflow server.

Although three examples of parameters related to the incident are described, it should be understood that the techniques described herein are not so limited. Any number of parameters (e.g. crowd density, crowd movement direction, number of participants, etc.) could also be specified. What should be understood is that incident parameters, whatever those parameters may be, are used to determine if a workflow should be initiated based on the artificial event notification.

In block 1315, an artificial event notification is received from a source external to a security ecosystem. The artificial event notification is related to an incident. As explained above, the artificial event notification may come from an external system directly or it may come from an aggregation service. The artificial event notification may include parameters related to the incident. These parameters may be used by the workflow server when determining if a workflow will be initiated.

In block 1320, the workflow server receives the artificial event notification based on a physical proximity of the workflow server to the source external to the security ecosystem. In some cases, the source external to the security ecosystem may be reporting incidents that do not occur within sufficiently close proximity to the enterprise operating the security ecosystem. In other words, the incidents are occurring far enough away from the security ecosystem that the workflow server would never initiate a workflow based on the incident. In such a case, the workflow server would not receive artificial events for such incidents.

In block 1325, the artificial event notification is mapped to a currently existing workflow within the workflow server. The currently existing workflow is associated with an internal trigger. As described above, the artificial event notification is not itself a trigger that would be recognized by the workflow server. Instead, the information included in the artificial event notification is analyzed to determine if the incident being reported is similar to an incident for which there is an existing workflow. In some cases, there may be multiple workflows that could be initiated based on the contents of the artificial event notification. In such cases, the workflow server determines the workflow that is most similar to the incident being reported.

In block 1330, it may be determined if the artificial event notification is actionable prior to initiating the currently existing workflow. For example, in block 1330, the most appropriate currently existing workflow may be selected. However, it may not be appropriate to initiate that workflow, as the artificial event may no longer be actionable. As described above, the artificial event may no longer be actionable for many reasons, including that the incident occurred too long ago, occurred too far away, or is outside the scope of the authority of the security ecosystem (e.g. campus security guard can't detain people off campus, etc.). What should be understood is that not all artificial events are actionable.

In block 1335, the artificial event notification is logged as non-actionable based on the determination in block 1330. Logging non-actionable artificial event notifications may allow the system to be finer tuned in the future. For example, artificial event notifications are frequently deemed non-actionable based on timeliness or proximity, the reporting criteria sent to the aggregation server/used by the workflow server may be modified such that those types of artificial event notifications are no longer sent/are ignored.

In block 1340, the currently existing workflow is initiated based on the artificial event notification without receiving the internal trigger. Once the currently existing workflow that is most closely associated with the artificial event notification is determined, the workflow server may initiate that workflow. What should be noted is that the trigger for that workflow is never received, either from the within or outside the security ecosystem. Instead, the artificial event notification was analyzed to determine which workflow should be initiated. The artificial workflow notification comes from a source that is external to the security ecosystem.

FIG. 14 is an example flow chart 1400 for the aggregator service querying the workflow server to determine when to send an artificial event. In block 1405, a query including an event type is received from the source external to the security ecosystem. The source external to the security ecosystem could be a source such as the aggregation service. In some cases, the source external to the security ecosystem may come directly from an external system (e.g. tip submit system, etc.). What should be understood is that the query includes an event type.

The event type may be the type of events the workflow server is interested in receiving. For example, as described with respect to block 1305, the workflow server may register with the aggregation service to specify the types of incidents for which artificial event notifications should be sent.

In block 1410 an event type relevance of the event type is determined. As explained above, just because an incident has occurred does not necessarily mean that the workflow server will decide to initiate a workflow. First, a decision is made as to if the event type, given the parameters sent from the source external to security ecosystem, warrant an workflow to be initiated.

In block 1415, determining the event type relevance further includes determining workflows in the workflow server that are compatible with the event type. As explained above with respect to FIG. 12, not every workflow is compatible with every incident type. A workflow used for responding to loitering may not be appropriate for responding to an assault incident. In this block, workflows that are compatible (e.g. relevant, etc.) to the event type are determined.

In block 1420, the determined workflows are ranked. For example, the workflows are ranked based on how relevant each workflow is to the particular event that has been in the query from the source external to the security ecosystem. For example, a loitering workflow for an in building location may be ranked higher than a location immediately outside the building, which may in turn be ranked higher than a loitering workflow for the perimeter of the building.

In block 1425, the determined workflows are analyzed based on acceptable time delay and location of the event type. For example, if the event type in the query was related to an event that occurred long ago, and thus may no longer be actionable, that particular workflow may be excluded from consideration for initiation. Likewise, if the location of the event type indicates that the workflow server would not be interested in the event based on the event not matching a location for the determined workflow, that workflow may also be excluded. In other words, event types that are not acceptable in terms of time or distance may be discarded.

In block 1430, the query is responded to with the event type relevance. The source external to the security ecosystem uses the event type relevance to determine if the artificial event notification is sent to the workflow server. In other words, prior to sending the artificial event notification, the source external to the security system may look at the response to the query to determine if this event type is one that the workflow server is interested in. If the query response indicates the workflow server is not interested in this type of event, the artificial event notification can be omitted. However, if the event type is of a type that the query server is interested in, the artificial event notification may be sent.

It should be noted that the process of querying the workflow server is optional. In some implementations, the source external to the security ecosystem will always send artificial event notifications to the workflow server. It is then left to the workflow server to determine a workflow, if any, that will be executed in response to the artificial event notification.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, implement electronic workflows, and the like).

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium (e.g. non-transitory) having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of initiating an existing workflow at a workflow server based on an artificial event notification comprising:
receiving, from a source external to a security ecosystem, an artificial event notification, the artificial event notification related to an incident;
mapping the artificial event notification to a currently existing workflow within the workflow server, the currently existing workflow associated with an internal trigger; and
initiating the currently existing workflow based on the artificial event notification without receiving the internal trigger.

2. The method of claim 1 further comprising:
determining if the artificial event notification is actionable prior to initiating the currently existing workflow; and
logging the artificial event notification as non-actionable based on the determination.

3. The method of claim 1 further comprising:
registering the workflow server with the source external to the security ecosystem, the registration including types and parameters of incidents for which the workflow server is interested in receiving artificial event notifications.

4. The method of claim 3 wherein the parameters include at least one of a location of the incident, a time of incident occurrence, and an incident type.

5. The method of claim 1 further comprising:
receiving, from the source external to the security ecosystem, a query including an event type;
determining an event type relevance of the event type; and
responding to the query with the event type relevance, wherein the source external to the security ecosystem uses the event type relevance to determine if the artificial event notification is sent to the workflow server.

6. The method of claim 5 wherein determining the event type relevance further includes:
determining workflows in the workflow server that are compatible with the event type;
ranking the determined workflows; and
analyzing the determined workflows based on acceptable time delay and location of the event type.

7. The method of claim 1 wherein the workflow server receives the artificial event notification based on a physical proximity of the workflow server to the source external to the security ecosystem.

8. A system for initiating an existing workflow at a workflow server based on an artificial event notification comprising:
a processor; and
a memory coupled to the processor, the memory containing a set of instructions thereon that when executed by the processor cause the processor to:
receive, from a source external to a security ecosystem, an artificial event notification, the artificial event notification related to an incident;
map the artificial event notification to a currently existing workflow within the workflow server, the currently existing workflow associated with an internal trigger; and
initiate the currently existing workflow based on the artificial event notification without receiving the internal trigger.

9. The system of claim 8 further comprising instructions to:
determine if the artificial event notification is actionable prior to initiating the currently existing workflow; and
log the artificial event notification as non-actionable based on the determination.

10. The system of claim 8 further comprising instructions to:
register the workflow server with the source external to the security ecosystem, the registration including types and parameters of incidents for which the workflow server is interested in receiving artificial event notifications.

11. The system of claim 10 wherein the parameters include at least one of a location of the incident, a time of incident occurrence, and an incident type.

12. The system of claim 8 further comprising instructions to:
receive, from the source external to the security ecosystem, a query including an event type;
determine an event type relevance of the event type; and
respond to the query with the event type relevance, wherein the source external to the security ecosystem uses the event type relevance to determine if the artificial event notification is sent to the workflow server.

13. The system of claim 12 wherein determining the event type relevance further includes instructions to:
determine workflows in the workflow server that are compatible with the event type;
rank the determined workflows; and
analyze the determined workflows based on acceptable time delay and location of the event type.

14. The system of claim 8 wherein the workflow server receives the artificial event notification based on a physical proximity of the workflow server to the source external to the security ecosystem.

15. A non-transitory processor readable medium containing a set of instructions thereon that when executed by a processor cause the processor to:
receive, from a source external to a security ecosystem, an artificial event notification, the artificial event notification related to an incident;
map the artificial event notification to a currently existing workflow within the workflow server, the currently existing workflow associated with an internal trigger; and
initiate the currently existing workflow based on the artificial event notification without receiving the internal trigger.

16. The medium of claim 15 further comprising instructions to:
determine if the artificial event notification is actionable prior to initiating the currently existing workflow; and
log the artificial event notification as non-actionable based on the determination.

17. The medium of claim 15 further comprising instructions to:
register the workflow server with the source external to the security ecosystem, the registration including types and parameters of incidents for which the workflow server is interested in receiving artificial event notifications.

18. The medium of claim 17 wherein the parameters include at least one of a location of the incident, a time of incident occurrence, and an incident type.

19. The medium of claim 15 further comprising instructions to:
receive, from the source external to the security ecosystem, a query including an event type;
determine an event type relevance of the event type; and
respond to the query with the event type relevance, wherein the source external to the security ecosystem uses the event type relevance to determine if the artificial event notification is sent to the workflow server.

20. The medium of claim 17 wherein determining the event type relevance further includes instructions to:
determine workflows in the workflow server that are compatible with the event type;
rank the determined workflows; and
analyze the determined workflows based on acceptable time delay and location of the event type.
